(19) United States
(12) Patent Application Publication
(10) Pub. No.: US 2015/0213137 A1
(43) Pub. Date: Jul. 30, 2015

(54) SYSTEMS AND METHODS FOR PROVIDING A SOCIAL NETWORK ENHANCEMENT TO A WEBSITE

(71) Applicant: Pushup Social, LLC, St. Louis, MO (US)

(72) Inventors: Dan Lohman, St. Louis, MO (US); Jan Andersen, St. Louis, MO (US); Yomi Toba, St. Louis, MO (US)

(21) Appl. No.: 14/588,747

(22) Filed: Jan. 2, 2015

Related U.S. Application Data
(60) Provisional application No. 61/923,077, filed on Jan. 2, 2014.

(51) Int. Cl. G06F 17/30; H04L 29/08

(52) U.S. Cl. CPC G06F 17/30867; H04L 67/02

(57) ABSTRACT

Aspects of the present disclosure involve a social network system that enables users of an existing website to participate in a social network generated for display at the existing website. In one aspect, the generated social network is accessible only by visitors to the existing website, such that an intimate community of like-minded users may interact. In another aspect, the social network is automatically generated and displayed on the existing website, while the execution of the underlying applications are performed by a third-party, such that the owners of the existing website need not invest in additional hardware to provide a social network for their customers.

### CROSS REFERENCE TO RELATED APPLICATIONS

This application claims priority to U.S. Provisional Patent Application Ser. No. 61/923,077 filed Jan. 2, 2014, and entitled “Systems and Methods for Providing a Social Network Enhancement to a Website,” the entire contents of which are incorporated herein by reference in its entirety.

### TECHNICAL FIELD

Aspects of the present disclosure relate to systems and methods for adding a social network and other functionality to an existing or third-party website.

### BACKGROUND

Social networks sites have become a near ubiquitous means for communicating and interacting with others. While these social network sites allow users to share content and information, the sites often force users to interact within the confines of each social network site. For example, these social network sites often require users to seek out one or more redundant groups within the framework of the sites to engage with others on particular topics or interests.

Additionally, the typical social network sites do not allow users to interact at third-party web pages or sites without first visiting and logging into the social network's own separate site. As such, there exists a need for system and method to generate and provide a social network and related functionality at a stand-alone third-party site without requiring extensive modification of the third-party site.

### SUMMARY

The present disclosure generally relates to systems and methods for enhancing an existing or third party website, by providing one or more interactive overlays or widgets that allow an administrator of the website to provide unique social network for users of the website. In one aspect, a method for providing social network enhancement includes generating, at a processor, instructions to display an overlay and/or bar for display at a website accessed at a client computing device, wherein the website is an existing website executing on a website server. The method also includes receiving, at the processor, post data input into a form at the client computing device by a user of the website, storing the post data at a database, and transmitting, at the processor, the post data to the website server, wherein the post data is displayed within the overlay and/or bar.

In another embodiment, a method for providing a social network enhancement includes generating, at a processor, instructions to display an overlay and/or bar for display at a website accessed at a client computing device, wherein the website is an existing website executing on a website server. The method also includes receiving, at the processor, post data input into a form at the client computing device by a user of the website and storing the post data at a database. The processor also transmits the post data to the website server, wherein the post data is displayed within the overlay and/or bar. The processor also receives a request for analytic data, wherein the analytic data relates to activity be one or more users of the website, and transmits analytic data to the website server, wherein an administrator of the website access the analytic data.

In yet another embodiment, a system for providing a social network enhancement includes a computing device, further including a processor and memory, to generate, at the processor, instructions to display an overlay and/or bar for display at a website accessed at a client computing device, wherein the website is an existing website executing on a website server. The processor also receives post data input into a form at the client computing device by a user of the website and storing the post data at a database. The processor also transmits the post data to the website server, wherein the post data is displayed within the overlay and/or bar. The processor also receives a request for analytic data, wherein the analytic data relates to activity be one or more users of the website, and transmits analytic data to the website server, wherein an administrator of the website access the analytic data.

### BRIEF DESCRIPTION OF THE DRAWINGS

FIG. 1 is a block diagram illustrating a computing environment according to aspects of the present disclosure.

FIG. 2 is a block diagram of a website server according to aspects of the present disclosure.

FIG. 3 is a flowchart and block diagram of a computing environment for installing social network on an existing website according to aspects of the present disclosure.

FIG. 4 is a flowchart and block diagram of a computing environment for registering users with the installed social network on an existing website according to aspects of the present disclosure.

FIG. 5 is a flowchart and block diagram of a computing environment that enables users to post data to the installed social network according to aspects of the present disclosure.

FIG. 6 is a flowchart and block diagram of a computing environment that enables monitoring of the user activity on the installed social network according to aspects of the present disclosure.

FIG. 7 is a block diagram of a computing environment that enables monitoring of the user activity on the installed social network according to aspects of the present disclosure.

The foregoing and other objects, features, and advantages of the present disclosure set forth herein will be apparent from the following description of particular embodiments of those inventive concepts, as illustrated in the accompanying drawings. It should be noted that the drawings are not necessarily to scale; instead, the emphasis is being placed on illustrating the principles of the inventive concepts. Also in the drawings, the like reference characters refer to the same parts throughout the different views. The drawings depict only typical embodiments of the present disclosure and, therefore, are not to be considered limiting in scope.

### DETAILED DESCRIPTION

Aspects of the present disclosure describe systems and methods for installing and enabling a social network and associated functionality on an existing website. In various aspects, the installed social network allows visitors to the website to interact with one another without the need to visit or register with a stand-alone third-party social network website, such as Facebook. In one aspect, an owner or administrator of a website may install the social network enhancement system, referred to herein as the Social Networking Enhancement (SNE) system on their website. The SNE system may appear as an overlay, bar, and/or a toolbar, or other suitable similar graphical interface that is displayed over the website. Once requested, all features of the social network are available on the website as soon as the script of executable instructions is added to the Hypertext Markup Language (HTML) or other markup language for the website.

In various aspects, the SNE application uses cross-domain data transfers and data access. As such, data is continuously transferred back and forth from registered sites running the SNE system and SNE system servers.

The website users continuously interact with the website as normal along with content retrieved from the SNE system servers that has been displayed over the website. In this manner, the SNE system is not incorporated or displayed within a frame of the website, but rather as an overlay and/or bar or toolbar. In various aspects, the combination of a simple and easy installation and implementation (i.e. a few lines of JavaScript in one embodiment) on an existing website, along with the ability to provide the full breadth of common social network functionality to the website allow the SNE system to easily enhance or improve existing websites and the user experience associated therewith.

The system disclosed herein allows website owners to provide a relevant close-knit social network that allows users to: register on the social network at the existing website, send messages to other users, upload media, add status updates, and build a network of connections (friends, colleagues, family members). In addition, the SNE system allows website owners and administrators to a create relevant discussions, polls, folders, and albums for their user, send messages to the users, and monitor the activity of the users to improve the website performance and content.

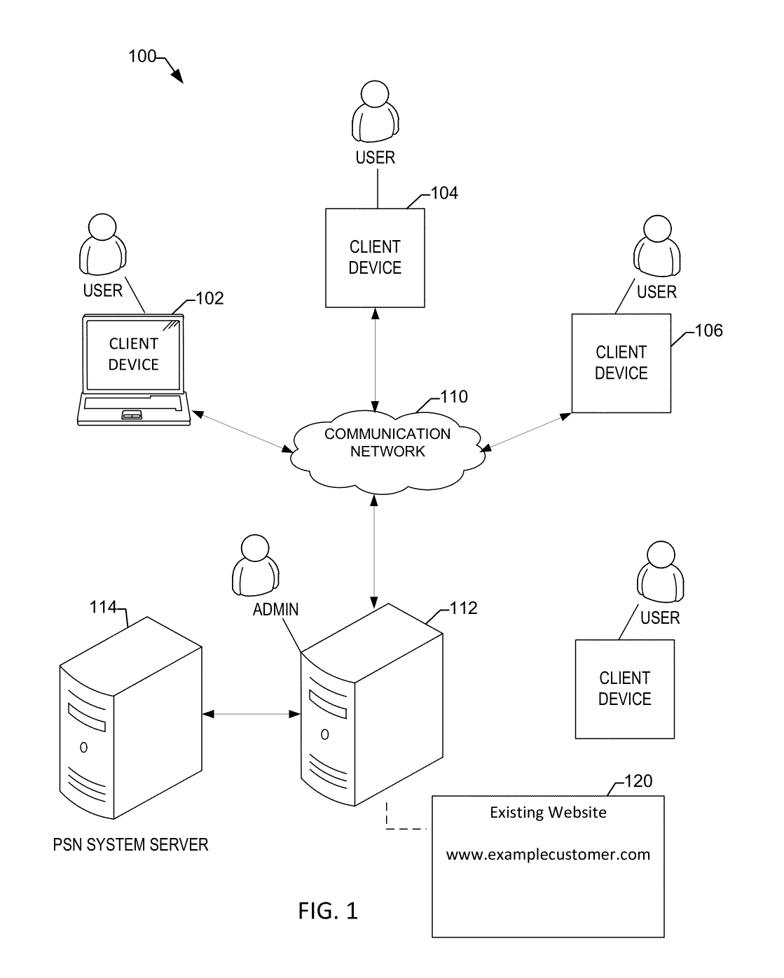

FIG. 1 illustrates an example computing system 100 suitable for implementing various embodiments disclosed herein. End users that visit a website and interact with a social network system enabled thereon may access the website 120 by interacting with client devices 102-108, which may be a personal computer, work station, server, mobile device, mobile phone, processor, and/or other processing device, and may include, or otherwise be equipped with, various interface components capable of receiving, presenting, and/or interacting with the website and components thereof, including an SNE system. For example, in one particular embodiment, each client device 102-108 may include: a communication system to communicate via a wireline and/or wireless communications, such as through the Internet, an Intranet, and Ethernet network, a wireline network, a wireless network, and/or another communication network; a display (not shown) for viewing data, such as a computer monitor; and an input/output device (not shown), such as a keyboard or a pointing device (e.g., a mouse, trackball, pen, touch pad, or other device) for entering data and navigating through data, such as audio, video, and/or other multimedia data.

The client devices 102-108 may view and interact with the website 120 that is hosted on a website server 112 via communication network 110. The communication network 110 may be the Internet, an Intranet, a local area network, a wireless local network, a wide area network, or another communication network, as well as combinations of networks and may transmit such data according to various protocols as are generally known in the art, such as an Internet Protocol/Transmission Control Protocol (IP/TCP), or other protocol.

The website server 112 may be any computing device and/or other processing device and may include one or more processors that process software or other machine-readable instructions, such as the instructions, processes, and/or functions for generating and transmitting the website and may include a memory to store the software or other machine-readable instructions and data. The memory may include volatile and/or non-volatile memory. Additionally, the website server 112 may include a communication system to communicate via a wireline and/or wireless communications, such as through the Internet, an Intranet, and Ethernet network, a wireline network, a wireless network, and/or another communication network. The website server 112 may further include a display (not shown) for viewing data, such as a computer monitor, and an input device (not shown), such as a keyboard or a pointing device (e.g., a mouse, trackball, pen, touch pad, or other device) for entering data and navigating through data, including exams, images, documents, structured data, unstructured data, HTML pages, other web pages, and other data.

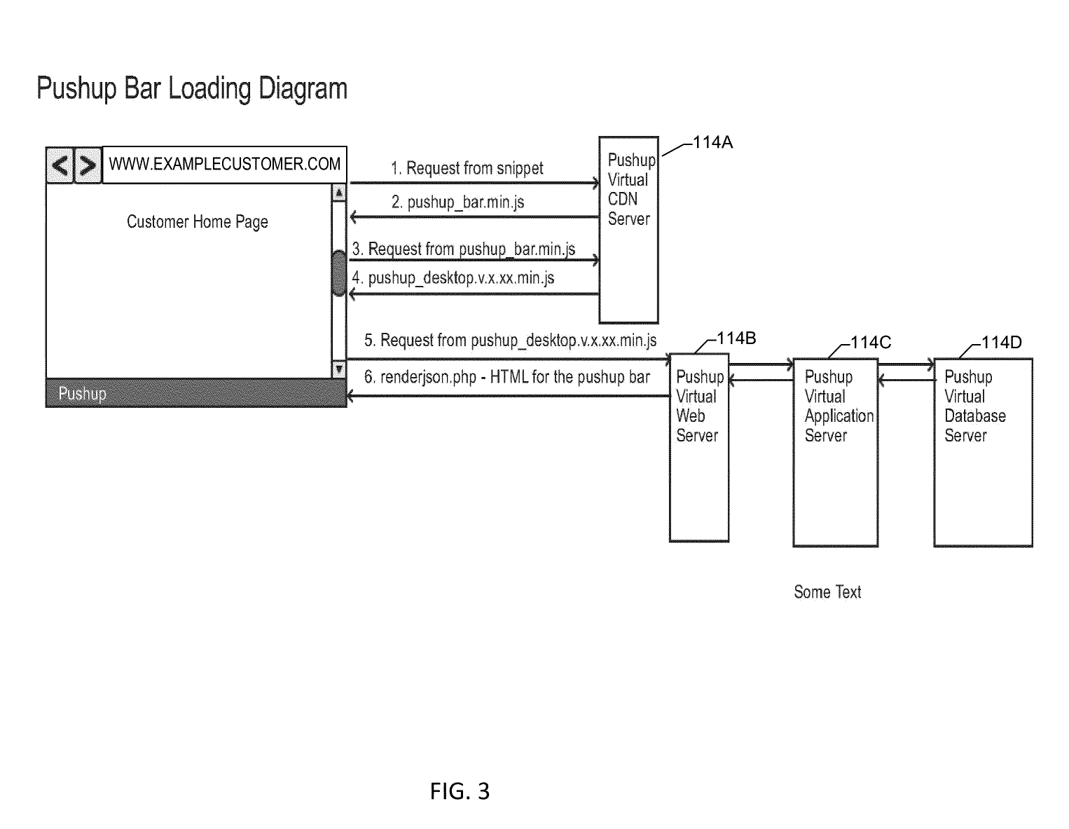

The web server 112 is also in communication with one or more SNE systems or servers 114. The SNE system/server 114 may be any computing device and/or other processing device and may include one or more processors that process software or other machine-readable instructions, such as the instructions, processes, and/or functions for generating and transmitting the SNE system and may include a memory to store the software or other machine-readable instructions and data. The memory may include volatile and/or non-volatile memory. Additionally, the SNE system server 114 may include a communication system to communicate via a wireline and/or wireless communications, such as through the Internet, an Intranet, and Ethernet network, a wireline network, a wireless network, and/or another communication network. The SNE system server 114 may further include one or more virtual servers 114A-D that perform various functions. For example, the SNE system server 114 may include a web server, application server, and a database. Although shown as separate computing devices in FIGS. 3-6, the functionality of the SNE web server, application server, and database server may be embodied in a single computed device or server.

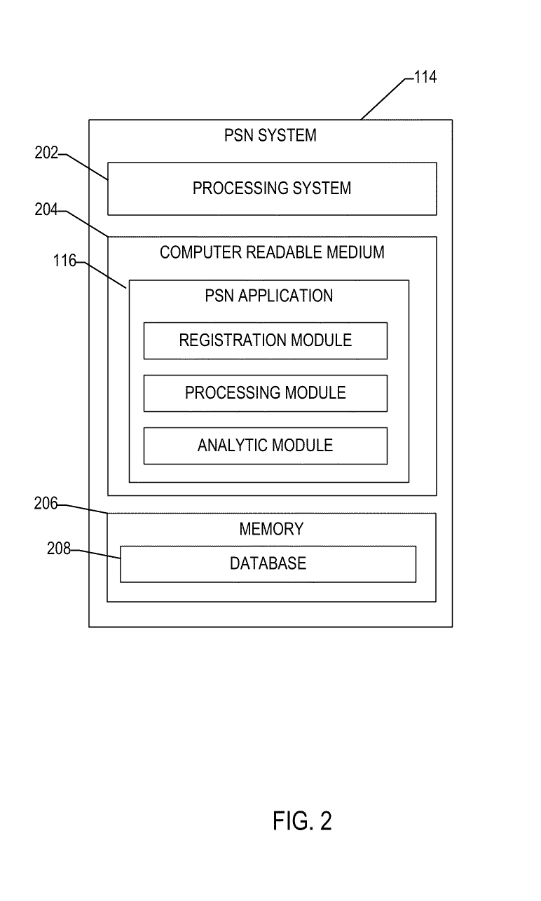

FIG. 2 is an example block diagram illustrating various hardware and/or software components of the SNE system server 114 according to one exemplary embodiment of the present disclosure. The SNE system server 112 may include a processor 202 that may be used to execute one or more social network applications 116 that generate the various displays, forms, and other data that are displayed with the website 120 to the end user at the client devices 102-108. The processor 202 may include memory and/or be in communication with a memory 206, which may include volatile and/or non-volatile memory and may include various other processing computing components. The SNE system server 114 may include a database 208. The database 208 may be a general repository of data including user credentials and other user data, user provided media and posts, and/or any other data relating to the social network provided by the SNE system. The database 208 may include memory and one or more processors or processing systems to receive, process, query and transmit communications and store and retrieve such data. In another aspect, the database 208 may be a database server.

Returning to FIG. 2, the SNE system server 114 may include a computer readable media (“CRM”) 204, which may include computer storage media, communication media, and/or another available computer readable media medium that can be accessed by the processor 202. For example, CRM 204 may include non-transient computer storage media and communication media. By way of example and not limitation, computer storage media includes memory, volatile media, non-volatile media, removable media, and/or non-removable media implemented in a method or technology for storage of information, such as machine/computer readable/executable instructions, data structures, program modules, or other data. Communication media includes machine/computer readable/executable instructions, data structures, program modules, or other data. The CRM 204 may store executable instructions to implement the SNE system and application. Generally, program modules include routines, programs, instructions, objects, components, data structures, etc. that perform particular tasks or implement particular abstract data types. For example, the SNE application 116 may be a module for registering websites and users, a module for processing data, and a module for analyzing user activity, among others.

FIGS. 3-6 illustrate various environments and methods for installing and executing various portions and functionality of the SNE system and associated data, scripts, and. As shown, the SNE system and associated data, scripts, and computer devices may be referred to by one or more trade names or business names. For example, in FIGS. 3-6, the SNE system and associated systems, features, structures and/or applications are referred to with the trade name “Pushup” or “pushup”. The terms “Pushup” or “pushup” are not do not necessarily describe or convey any meaningful limitations regarding the functionality or hardware composition of the systems and methods disclosed herein.

FIG. 3 is a flow chart and block diagram of a computing environment for installing social network on an existing website according to one aspect. As shown, a website owner or operator may desire to install and use the SNE system with their website. To install the SNE system, the website owner transmits a request to an SNE server content delivery network (CDN) server 302. In response, the CDN server transmits data to the website server 112. In one aspect, the data transmitted by the CDN server is a code, including but not limited to a JavaScript (JS) snippet that is installed by the website owner.

After installation, the JS snippet generates a request for additional data or instructions for the subsequent execution and generation of a graphical interface bar that is displayed as a bar on the website owner's website. In response to the request from the first JS snippet, executed at the website owner's computing device 112, the CDN server transmits another response that includes another snippet for the SNE bar.

Once the SNE bar snippet is executed at the website owner's computing device, the bar snippet generates a request for additional third party JavaScript libraries to run the SNE system, as well as an SNE application JavaScript file. In response, the CDN server transmits the latest version of a JS application that is executed at the website owner's server to execute one or more of the SNE web applications. The JS application also generates a request for instructions, including but not limited to HTML language instructions for the generation and display of the SNE bar. This request is received at one or more SNE web servers.

The SNE servers return the instructions for the SNE bar. The instructions transmitted by the SNE server may vary, depending on whether the website owner is logged in to the SNE system or not. For example, website owners that are logged into the SNE system also receive the information used to populate the local SNE system information data and pointer hovers on the website. As used herein, pointer hovers refer to an object or a location in a website display where upon placing or hovering a pointer, such as but not limited to, a cursor or an arrow, over the object or location, an event occurs. These events include but are not limited to the display of pop-up windows, pull-down, menus, or description boxes. Once the SNE instructions are received, the SNE application executing at the website owner's server 112 generates the SNE overlay and/or bar for display on the website owner's website.

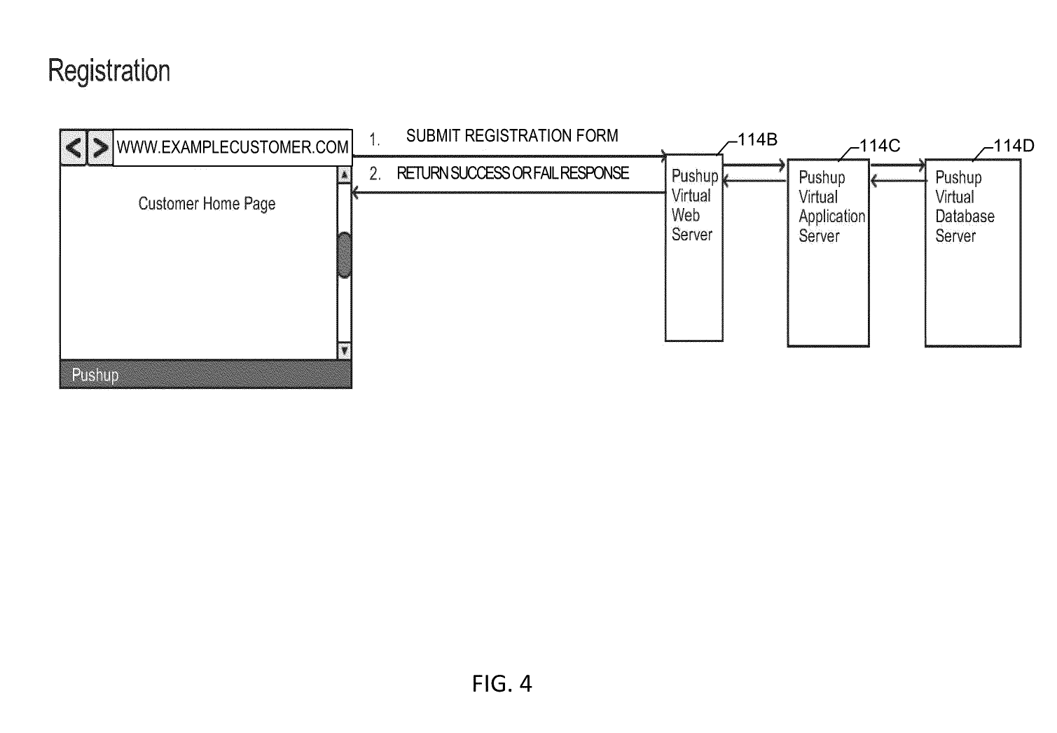

Referring now to FIG. 4, an embodiment of a method and computing environment for registering or logging an end user into the SNE system via the existing website is shown. Once a user at a client device has navigated to the existing website that has the SNE bar installed and indicated a desire to use the SNE system, a registration form is generated by the SNE application executing at the website owner's computing device. The use inputs data into the registration form using the input device of the client device. The user submits the completed registration form, which is validated by the SNE application and then transmitted to the SNE web server. In one aspect, the SNE webserver validates the form one or more additional times. After validation, the web server returns either a fail message, indicating that registration cannot proceed, or the web server, in communication and conjunction with one or more of the application server and database server, processes the data input to the registration form and returns an indication of a successful registration. In one aspect, the web server also generates a session cookie, to allow the user to register and or subsequently login automatically without confirmation.

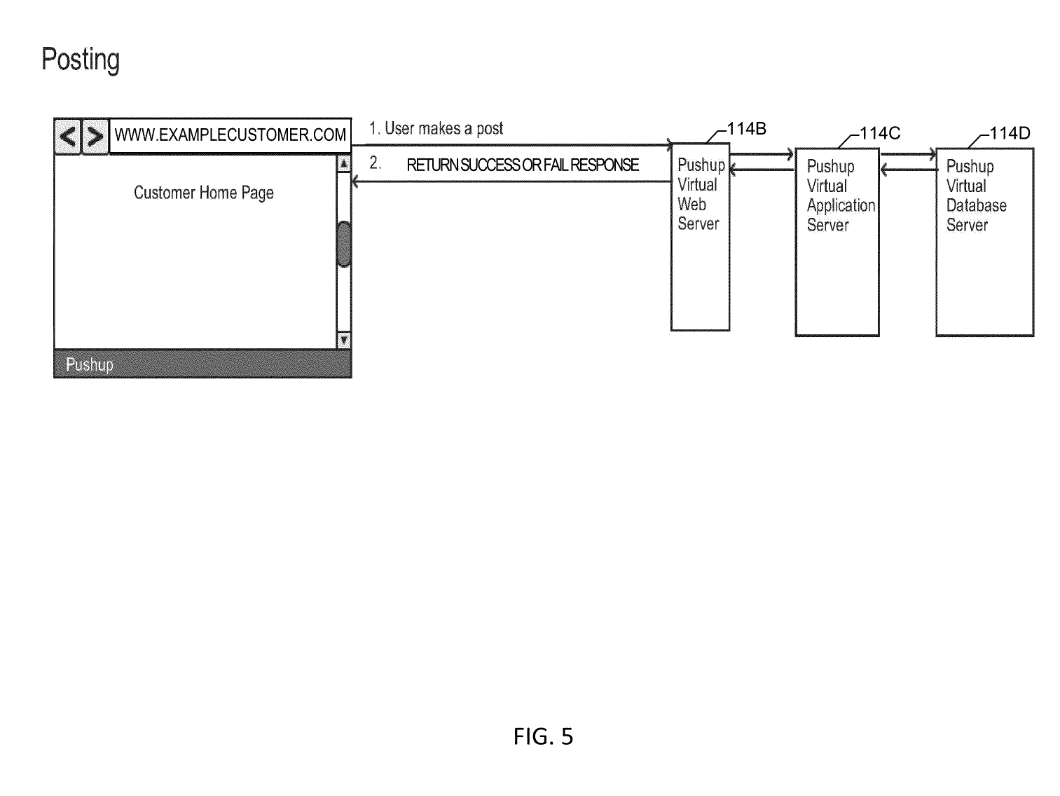

An embodiment of a method and computing environment for an end user to make a post to the SNE system is shown in FIG. 5. Similar to existing social network systems, a posting input form is generated for display at the client device 102-108. Using the input device, the end user inputs data into the posting input form. The input form is then transmitted via the SNE bar to the SNE web server, where the post is validated. In response, the webserver may generate with a fail response when appropriate. Alternately, the web server may transmit the data contained in the input form to the application server, which stores the post in a database 208, and generate a success response that is displayed for the end user to indicate that the post was made.

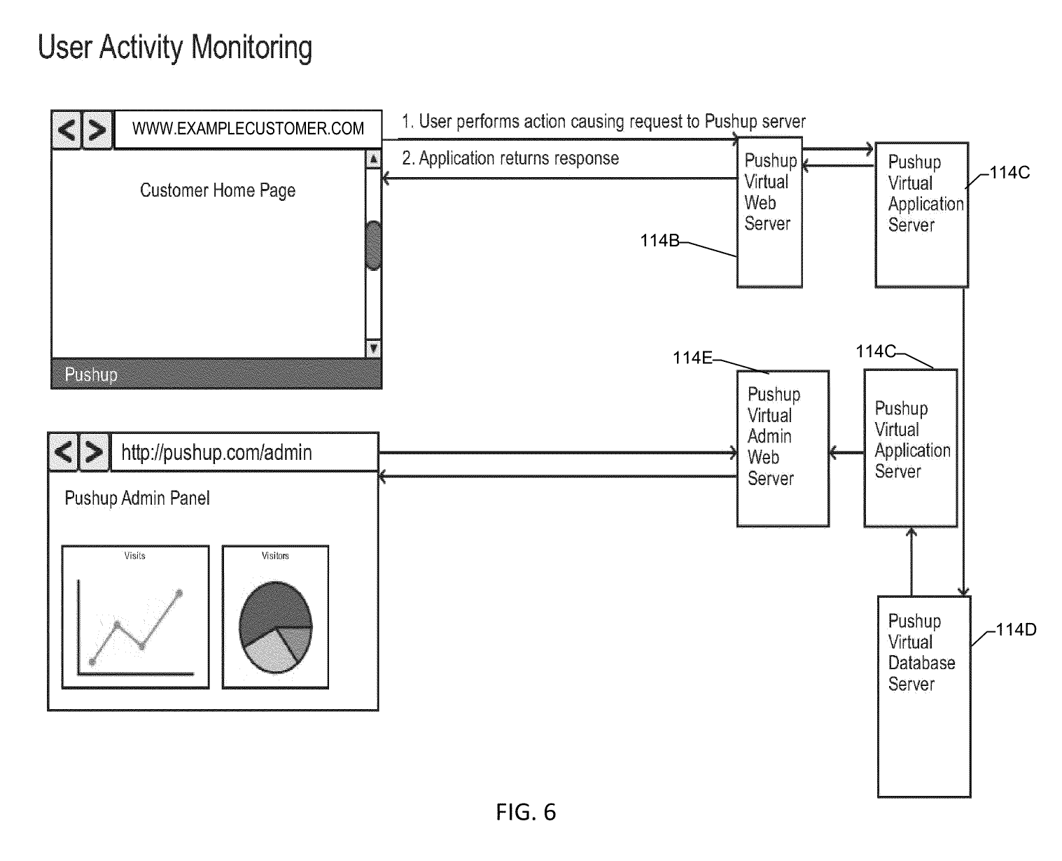

Referring now to FIG. 6, another aspect of the SNE system is the ability for the website owner to monitor and analyze the activity of end users who use the SNE system through the website. By way of example and not limitation, each action performed by the end user that generates a request or any other transmission to the SNE web server may be identified and further transmitted to the application server where the action is recorded in the database. The web server generates a normal response to the user's action such that the monitoring functionality does not hinder the end users experience using the SNE social network.

To monitor the activity of the end users on the website, the website owner or any other administrator for the website may access an administrator control panel via a login form generated by the SNE application. Using the control panel, the administrator may request data regarding the users and their activities from the SNE application server and database. By way of example and not limitation, the monitored user activities may include the number and frequency of user log-ins and posts, as well as the type of posts made by the users (i.e. initial posts or reply posts). Other analytics regarding the end users may also be monitored and analyzed.

In response to the administrator inquiry, the web server generates a response containing aggregated data of the website's users from the database via the application server. The aggregated data may be presented in text form, as a graph or any suitable and/or desired format.

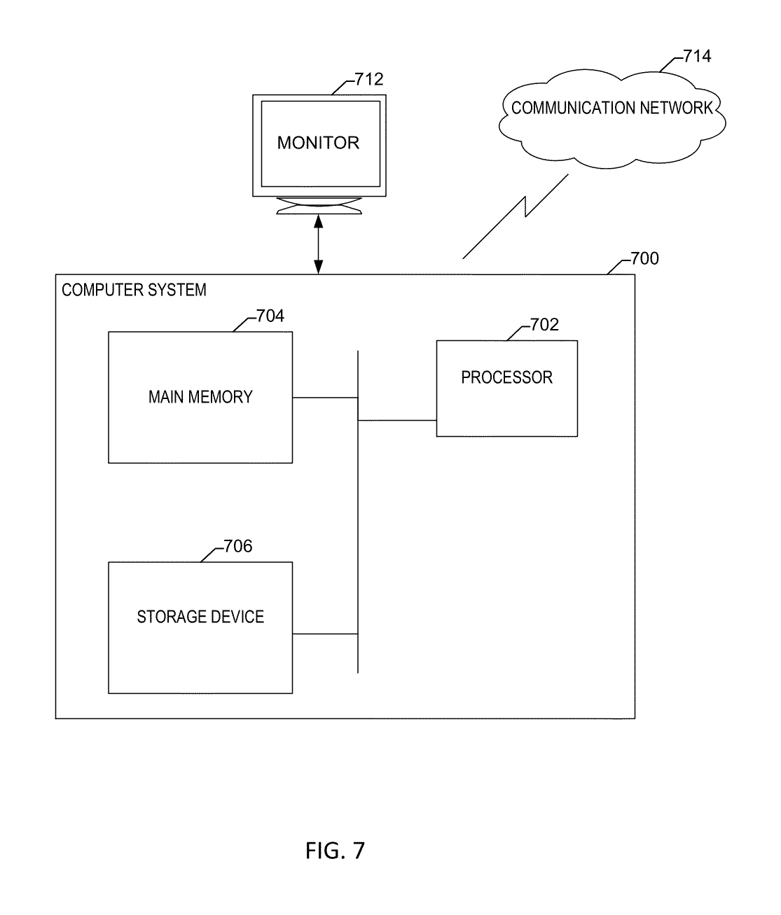

The various inventive concepts described above may be implemented on virtually any type of computer regardless of the platform being used. For example, as shown in FIG. 7, a computer system 700 includes a processor 702, associated memory 704, a storage device 706, and numerous other elements and functionalities typical of today's computers (not shown). The computer 700 may also include input means, such as a keyboard and a mouse and output means, such as a monitor 712. The computer system 700 may be connected to a local area network (LAN) or a Wide area network (e.g., the Internet), such as communication network 714, via a network interface connection (not shown). Those skilled in the art will appreciate that these input and output means may take other forms.

The systems and methods disclosed herein may also include a number of other features and functionalities. By way of example, and not limitation, the social network system and methods disclosed herein may also be used for multi-user chats, chat rooms with automatic moderation, and direct messaging between users. The system may also incorporate, receive, and generate a data feed such as an RSS feed as well as providing a searchable index for user-generated content.

The system and methods may also be used to provide for the external sharing or exportation of data to other social networks, allows users to sign in with other social network logins, and to send invitations to join various networks using a user's contacts. The SNE system also incorporates mass-email capabilities and plugins for other content management systems. Moreover, the SNE system may be used to create subdomains for new communities that do not have existing websites.

In various embodiments, the SNE system 114 can be used to leverage content generated by users of the SNE system and other third party providers for various search engine optimization (SEO) practices. The system may also be used to leverage third-party content, such as content displayed on the existing website, including but not limited to content generated provided by other related and/or disparate third-parties.

In one embodiment, the SNE system server 114 is used to collect user-generated content. For example, the SNE system uses a secure hypertext transfer protocol (HTTPS) protocol via an SNE application programming interface (API) that allows authenticated clients the ability to create user accounts remotely. Any authenticated server providing the correct credentials matching a valid customer account can create user accounts. The accounts and other user information are then stored in SNE servers 114 and databases 208.

After account creation, a process of account authentication (e.g. OAuth) to provide SNE client applications 116 and the users thereof with secure “delegated access” to the resources of the SNE servers 114 and databases 208 resources on behalf of the resource owner (i.e. the account owner). When the SNE system authorizes account access, the SNE client applications 116 make API requests to retrieve previously generated content and to permit new content generation. By way of example and not limitation, the SNE client applications include the SNE bar, related mobile device applications, and any other authorized applications. This user-generated content is then saved on the SNE servers 114 and databases 208.

In another embodiment, the SNE system 114 generates and a universal resource identifier (URI) that is associated with the existing websites' server hostname. In one aspect, SEO for an existing website based on the user-generated content is related, at least in part, to the websites existing hostname. For example, administrators for a website that desires to use the SNE system 114, upload a SNE proxy script to their servers. In one embodiment, the script is accessible via a representational state transfer (REST) HTTP or HTTPS “get” request to the existing website domain. Thus, in response to query parameters at the SNE overlay that identify the URI, the SNE proxy script residing on the website's server will retrieve the requested content from SNE servers 114 and databases 208 and return or transmit the user-generated content for display on the website and/or SNE website bar or overlay. In one aspect, the SNE system 114 facilitates the retrieval of one or more users' post created on a particular website, and having a particular URI, however, the data is retrieved from the SNE servers 114 and databases 208.

In yet another embodiment, the user-generated content collected via the SNE system 114 may be used to generate and permit sitemap referencing for the existing websites. In one aspect, administrators of the website, modify any existing site map data or data structure to include an SNE system proxy script to request a website's site map based upon the website's user-generated content.

In various aspects, the content generated by users of the website site that is about or relevant to the website is collected and stored at the SNE system servers 114 and databases 208. This data is then suitable for indexing by search engines; such that searches for the collected user-data will be associated with the website; and thus, search results that include the user-generated content will direct users to the existing website. —In various aspects, embodiments of the systems and methods disclosed herein may be used in a mobile application. Similarly, the systems and methods may be adapted for use with mobile web browsers.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for providing social network enhancement, the method comprising:
generating, at a processor, instructions to display an overlay and/or bar for display at a website accessed at a client computing device, wherein the website is an existing website or a third-party website executing on a website server;
receiving, at the processor, post data input into a form at the client computing device by a user of the website;
storing the post data at a database; and
transmitting, at the processor, the post data to the website server, wherein the post data is displayed within the overlay and/or bar.

2. The method of claim 1, wherein the instructions to display the overlay are inserted into a markup language of the website.

3. The method of claim 1, wherein processor receives a request from the website server for one or more libraries, wherein the libraries permit additional social network functionality.

4. The method of claim 1, further comprising:
receiving, at the processor, a request for secure delegated access, wherein a user granted secure delegated access may generate user-content and retrieve previously generated content from the database; and
storing, the user-content at the database.

5. The method of claim 1, further comprising:
generating a universal resource identifier, wherein the universal resource identifier is associated with a hostname of the website;
receiving, at the processor, a query request from a social network enhancement script executing at the website server;
retrieving query data associated with the universal resource identifier from the database, in response to the query request; and
transmitting, at the processor, the retrieved data for display at the website; wherein the query data is user-generated content generated by users of the website.

6. The method of claim 5, wherein the processor permits access to the user-generated content for indexing by one or more search engines.

7. A method for providing social network enhancement, the method comprising:
generating, at a processor, instructions to display an overlay and/or bar for display at a website accessed at a client computing device, wherein the website is an existing website or a third-party website executing on a website server;
receiving, at the processor, post data input into a form at the client computing device by a user of the website;
storing the post data at a database;
transmitting, at the processor, the post data to the website server, wherein the post data is displayed within the overlay and/or bar;
receiving, at the processor, a request for analytic data, wherein the analytic data relates to activity be one or more users of the website; and
transmitting, at the processor, analytic data to the website server, wherein an administrator of the website access the analytic data.

8. The method of claim 7, wherein the instructions to display the overlay are inserted into a markup language of the website.

9. The method of claim 7, wherein processor receives a request from the website server for one or more libraries, wherein the libraries permit additional social network functionality.

10. The method of claim 7, further comprising:
receiving, at the processor, a request for secure delegated access, wherein a user granted secure delegated access may generate user-content and retrieve previously generated content from the database; and
storing, the user-content at the database.

11. The method of claim 7, further comprising:
generating a universal resource identifier, wherein the universal resource identifier is associated with a hostname of the website;
receiving, at the processor, a query request from a social network enhancement script executing at the website server;
retrieving query data associated with the universal resource identifier from the database, in response to the query request; and
transmitting, at the processor, the retrieved data for display at the website; wherein the query data is user-generated content generated by users of the website.

12. The method of claim 11, wherein the processor permits access to the user-generated content for indexing by one or more search engines.

13. A system for providing a social network enhancement to a website, the system comprising:
a computing device including a processor and memory, the processor to:
generate an overlay and/or bar for display at a website accessible at a client computing device, wherein the website is executed on a website server;
receive post data input into a form at the client computing device by a user of the website;
store the post data at a database;
transmit the post data to the website server, wherein the post data is displayed within the overlay and/or bar;
receive a request for analytic data, wherein the analytic data relates to activity be one or more users of the website; and
transmit analytic data to the website server, wherein an administrator of the website access the analytic data.

14. The system of claim 13, wherein the instructions to display the overlay are inserted into a markup language of the website.

15. The system of claim 13, wherein processor receives a request from the website server for one or more libraries, wherein the libraries permit additional social network functionality.

16. The system of claim 13, further comprising the processor to:
Receive a request for secure delegated access, wherein a user granted secure delegated access may generate user-content and retrieve previously generated content from the database; and
store the user-content at the database.

17. The system of claim 13, further comprising the processor to:
generate a universal resource identifier, wherein the universal resource identifier is associated with a hostname of the website;
receive a query request from a social network enhancement script executing at the website server;
retrieve query data associated with the universal resource identifier from the database, in response to the query request; and
transmit the retrieved data for display at the website; wherein the query data is user-generated content generated by users of the website.

18. The system of claim 17, wherein the processor permits access to the user-generated content for indexing by one or more search engines.
